(19) United States
(12) Patent Application Publication
(10) Pub. No.: US 2024/0397874 A1
(43) Pub. Date: Dec. 5, 2024

(54) SYSTEM AND METHOD FOR AN AGRICULTURAL HARVESTER

(71) Applicant: CNH Industrial Brasil Ltda., Nova Lima (BR)

(72) Inventors: DAENIO CLEODOLPHI, Piracicaba (BR); JOÃO AUGUSTO MARCOLIN LUCCA, Piracicaba (BR)

(21) Appl. No.: 18/680,565

(22) Filed: May 31, 2024

(30) Foreign Application Priority Data
May 31, 2023 (BR) 1020230106242

(51) Int. Cl. A01F 12/44; A01D 45/10; A01F 12/58

(52) U.S. Cl. CPC A01F 12/444; A01F 12/58; A01D 45/10

(57) ABSTRACT

A system for an agricultural harvester includes an extractor configured to separate debris from a crop and expel the debris therefrom. The extractor can include a hood and a fan assembly positioned at least partially within the hood and configured to generate a suction force to force the debris through the extractor. The fan assembly includes a fan blade. An actuator is configured to alter a position of the fan blade relative to an upper portion of the hood. A sensor system is configured to generate data indicative of one or more operating parameters or conditions of the extractor. A computing system is communicatively coupled to the sensor system and the actuator. The computing system being configured to receive the data from the sensor system and determine a defined position of the fan blades relative to the hood based at least in part on the data from the sensor system.

### FIELD OF THE INVENTION

The present disclosure relates generally to agricultural harvesters, such as sugarcane harvesters, and, more particularly, to systems and methods for extractors of the agricultural harvester.

### BACKGROUND OF THE INVENTION

Typically, agricultural harvesters include an assembly of processing components for processing harvested material. For instance, within a sugarcane harvester, severed sugarcane stalks are conveyed via a feed roller assembly to a chopper assembly that cuts or chops the sugarcane stalks into pieces or billets (e.g., six-inch sugarcane sections). The processed harvested material discharged from the chopper assembly is then directed as a stream of billets and debris past one or more extractors, within which the debris (e.g., dust, dirt, leaves, etc.) is separated from the sugarcane billets. The separated/cleaned billets then fall into an elevator assembly for delivery to an external storage device. Accordingly, systems and methods for operating the one or more extractors in various manners would be welcomed in the technology.

### BRIEF DESCRIPTION OF THE INVENTION

Aspects and advantages of the invention will be set forth in part in the following description, or may be obvious from the description, or may be learned through practice of the invention.

In some aspects, the present subject matter is directed to an extractor configured to separate debris from a crop and expel the debris therefrom. The extractor includes a hood and a fan assembly positioned at least partially within the hood and configured to generate a suction force to force the debris through the extractor. The fan assembly includes a fan blade. An actuator is configured to alter a position of the fan blade relative to an upper portion of the hood. A sensor system is configured to generate data indicative of one or more operating parameters or conditions of the extractor. A computing system is communicatively coupled to the sensor system and the actuator. The computing system being configured to receive the data from the sensor system and determine a defined position of the fan blades relative to the hood based at least in part on the data from the sensor system.

In some aspects, the present subject matter is directed to a computer-implemented method for agricultural harvesting. The method includes operating a fan assembly to generate a suction force within an extractor. The method also includes receiving, from a sensor system, data indicative of one or more operating parameters or conditions of the extractor. The method further includes determining, with a computing system, a defined position of a component of the fan assembly relative to a hood of the fan assembly based at least in part on the data from the sensor system.

In some aspects, the present subject matter is directed to an extractor configured to separate debris from a crop and expel the debris therefrom. The extractor includes a fan assembly positioned configured to generate a suction force to force the debris through the extractor. The fan assembly includes a fan blade. An actuator is configured to alter a position of the fan blade within the extractor. A sensor system is configured to generate data indicative of one or more operating parameters or conditions of the extractor. A computing system is communicatively coupled to the sensor system and the actuator. The computing system is configured to receive the data from the sensor system and activate the actuator to move the fan blade from a current position to a defined position based at least in part on the data from the sensor system.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of an agricultural harvester in accordance with aspects of the present subject matter;

FIG. 2 illustrates a perspective view of a primary extractor of the agricultural harvester in accordance with aspects of the present subject matter;

FIG. 3 illustrates a side plan view of a fan assembly having one or more fan blades in a first position within the primary extractor of the agricultural harvester in accordance with aspects of the present subject matter;

FIG. 4 illustrates a side plan view of a fan assembly having one or more fan blades in a second position within the primary extractor of the agricultural harvester in accordance with aspects of the present subject matter;

FIG. 5 illustrates a side plan view of a fan assembly having one or more fan blades in a third position within the primary extractor of the agricultural harvester in accordance with aspects of the present subject matter;

FIG. 6 illustrates an actuator in a first position and operably coupled with an arm of a support system in accordance with aspects of the present subject matter;

FIG. 7 illustrates an actuator in a second position and operably coupled with an arm of a support system in accordance with aspects of the present subject matter;

FIG. 8 illustrates an actuator in a first position and operably coupled with an arm of a support system in accordance with aspects of the present subject matter;

FIG. 9 illustrates an actuator in a second position and operably coupled with an arm of a support system in accordance with aspects of the present subject matter;

FIG. 10 illustrates an actuator in a first position and operably coupled with an arm of a support system in accordance with aspects of the present subject matter;

FIG. 11 illustrates an actuator in a second position and operably coupled with an arm of a support system in accordance with aspects of the present subject matter;

FIG. 12 illustrates an actuator in a first position and operably coupled with an arm of a support system in accordance with aspects of the present subject matter;

FIG. 13 illustrates an actuator in a second position and operably coupled with an arm of a support system in accordance with aspects of the present subject matter;

FIG. 14 illustrates a perspective view of a primary extractor of the agricultural harvester in accordance with aspects of the present subject matter;

FIG. 15 illustrates a schematic view of a system for a harvesting operation in accordance with aspects of the present subject matter;

FIG. 16 is a schematic block diagram illustrating portions of the system of FIG. 15 in accordance with aspects of the present subject matter;

FIG. 17 illustrates a flow diagram of a method for a harvesting operation in accordance with aspects of the present subject matter; and

FIG. 18 illustrates a flow diagram of a method for a harvesting operation in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part can be used with another embodiment to yield a still further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a harvested material within a fluid circuit. For example, “upstream” refers to the direction from which a harvested material flows, and “downstream” refers to the direction to which the harvested material moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

As used herein, a “desired foliage ratio” may be an input that is defined by an operator and/or any device. In addition, a “current foliage ratio” may be a detected foliage ratio of the system while the system is operating.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods for agricultural harvesters. In particular, the present subject matter is directed to systems and methods that can include an extractor configured to separate debris from a crop and expel the debris therefrom. The extractor includes a hood and a fan assembly positioned at least partially within the hood and configured to generate a suction force to force the debris through the extractor. The fan assembly includes a fan blade. An actuator is configured to alter a position of the fan blade relative to an upper portion of the hood. A sensor system is configured to generate data indicative of one or more operating parameters or conditions of the extractor. A computing system is communicatively coupled to the sensor system and the actuator. The computing system being configured to receive the data from the sensor system and determine a defined position of the fan blades relative to the hood based at least in part on the data from the sensor system. In various examples, the operational efficiency of the extractor may be altered based on the position of the fan blades within the extractor due to variations in turbulence, airflow, material impact within the extractor, and/or any other factors.

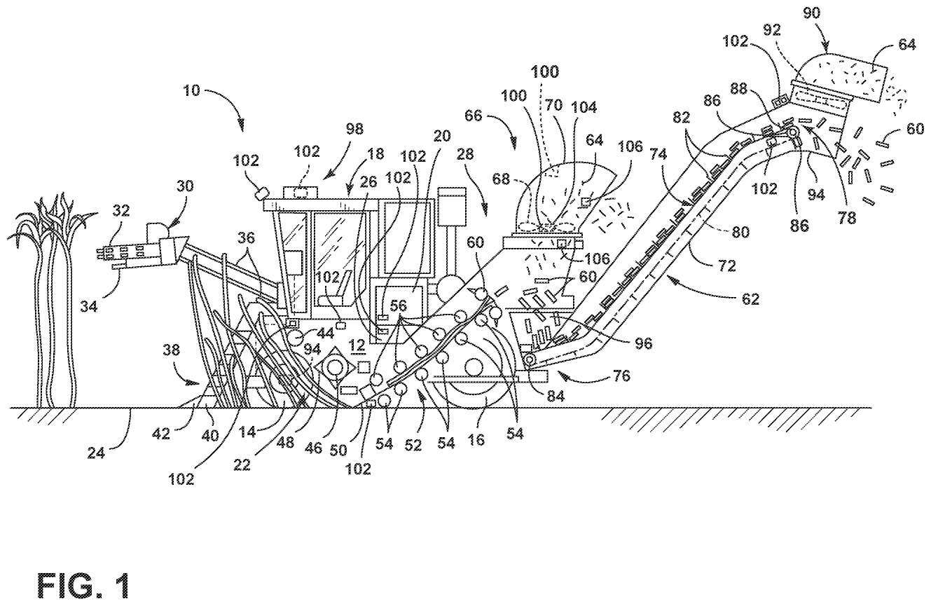

Referring now to the drawings, FIG. 1 illustrates a side view of an agricultural harvester 10 in accordance with aspects of the present subject matter. As shown, the harvester 10 is configured as a sugarcane harvester. However, in other embodiments, the harvester 10 may correspond to any other suitable agricultural harvester known in the art.

As shown in FIG. 1, the harvester 10 can include a frame 12, a pair of front wheels 14, a pair of rear wheels 16, and an operator's cab 18. The harvester 10 may also include a power source 20 (e.g., an engine) that powers one or both pairs of the wheels 14, 16 via a driveline assembly 22 (e.g., a transmission) to traverse a field 24. Alternatively, the harvester 10 may be a track-driven harvester and, thus, may include tracks driven by the power source 20 as opposed to the illustrated wheels 14, 16. The power source 20 may also drive a hydraulic fluid pump 26 to power various components of the harvester 10, including the driveline assembly 22.

The harvester 10 may also include a harvested material processing system 28 incorporating various components, assemblies, and/or sub-assemblies of the harvester 10 for cutting, processing, cleaning, and discharging sugarcane as the sugarcane is harvested from an agricultural field 24. For instance, the harvested material processing system 28 may include a topper assembly 30 positioned at the front end portion of the harvester 10 to intercept sugarcane as the harvester 10 is moved in a forward direction. As shown, the topper assembly 30 may include both a gathering disk 32 and a cutting disk 34. The gathering disk 32 may be configured to gather the sugarcane stalks so that the cutting disk 34 may be used to cut off the top of each stalk. As is generally understood, the height of the topper assembly 30 may be adjustable via a pair of arms 36, which may be hydraulically raised and lowered.

The harvested material processing system 28 may further include a harvested material divider 38 that extends upwardly and rearwardly from the field 24. In general, the harvested material divider 38 may include two spiral feed rollers 40. Each feed roller 40 may include a ground shoe 42 at its lower end portion to assist the harvested material divider 38 in gathering the sugarcane stalks for harvesting. Moreover, as shown in FIG. 1, the harvested material processing system 28 may include a knock-down roller 44 positioned near the front wheels 14 and a fin roller 46 positioned behind the knock-down roller 44. As the knock-down roller 44 is rotated, the sugarcane stalks being harvested are knocked down while the harvested material divider 38 gathers the stalks from agricultural field 24. Further, as shown in FIG. 1, the fin roller 46 may include a plurality of intermittently mounted fins 48 that assist in forcing the sugarcane stalks downwardly. As the fin roller 46 is rotated during the harvest, the sugarcane stalks that have been knocked down by the knock-down roller 44 are separated and further knocked down by the fin roller 46 as the harvester 10 continues to be moved in the forward direction relative to the field 24.

Referring still to FIG. 1, the harvested material processing system 28 of the harvester 10 may also include a base cutter assembly 50 positioned behind the fin roller 46. The base cutter assembly 50 may include blades for severing the sugarcane stalks as the sugarcane is being harvested. The blades, which may be located on a periphery section of the base cutter assembly 50, may be rotated by a hydraulic circuit. Additionally, in several embodiments, the blades may be angled downwardly to sever the base of the sugarcane as the sugarcane is knocked down by the fin roller 46.

Moreover, the harvested material processing system 28 may include a feed roller assembly 52 located downstream of the base cutter assembly 50 for moving the severed stalks of sugarcane from base cutter assembly 50 along the processing path of the harvested material processing system 28. As shown in FIG. 1, the feed roller assembly 52 may include a plurality of bottom rollers 54 and a plurality of opposed, top rollers 56. The various bottom and top rollers 54, 56 may be used to pinch the harvested sugarcane during transport. As the sugarcane is transported through the feed roller assembly 52, debris 64 (e.g., rocks, dirt, and/or the like) may be allowed to fall through bottom rollers 54 onto the field 24.

In addition, the harvested material processing system 28 may include a chopper assembly 58 located at the downstream end section of the feed roller assembly 52 (e.g., adjacent to the rearward-most bottom roller 54 and the rearward-most top roller 56). In general, the chopper assembly 58 may be used to cut or chop the severed sugarcane stalks into pieces or “billets” 60, which may be, for example, six (6) inches long. The billets 60 may then be propelled towards an elevator assembly 62 of the harvested material processing system 28 for delivery to an external receiver or storage device.

The pieces of debris 64 (e.g., dust, dirt, leaves, etc.) separated from the sugarcane billets 60 may be expelled from the harvester 10 through a primary extractor 66 of the harvested material processing system 28, which may be located downstream of the chopper assembly 58 and may be configured to extract the debris 64 outwardly from the harvester 10. A fan assembly 68 may be operably coupled with the primary extractor 66 for generating a suction force or vacuum sufficient to force the debris 64 through the primary extractor 66. The separated or cleaned billets 60, which may be heavier than the debris 64 expelled through the extractor 66, may then fall downward to the elevator assembly 62.

As shown in FIG. 1, the elevator assembly 62 may include an elevator housing 72 and an elevator 74 extending within the elevator housing 72 between a lower, proximal end portion 76 and an upper, distal end portion 78. In some examples, the elevator 74 may include a looped chain 80 and a plurality of flights or paddles 82 attached to and spaced on the chain 80. The paddles 82 may be configured to hold the sugarcane billets 60 on the elevator 74 as the sugarcane billets 60 are elevated along a top span of the elevator 74 defined between its proximal and distal end portions 76, 78. Additionally, the elevator 74 may include lower and upper sprockets 84, 86 positioned at its proximal and distal end portions 76, 78, respectively. As shown in FIG. 1, an elevator motor 88 may be coupled to one of the sprockets (e.g., the upper sprocket 86) for driving the chain 80, thereby allowing the chain 80 and the paddles 82 to travel in a loop between the proximal and distal ends 76, 78 of the elevator 74.

Moreover, in some embodiments, pieces of debris 64 (e.g., dust, dirt, leaves, etc.) separated from the elevated sugarcane billets 60 may be expelled from the harvester 10 through a secondary extractor 90 of the harvested material processing system 28 coupled to the rear end portion of the elevator housing 72. For example, the debris 64 expelled by the secondary extractor 90 may be debris 64 remaining after the billets 60 are cleaned and debris 64 expelled by the primary extractor 66. As shown in FIG. 1, the secondary extractor 90 may be located adjacent to the distal end portion 78 of the elevator 74 and may be oriented to direct the debris 64 outwardly from the harvester 10. Additionally, a fan assembly 92 may be mounted within the secondary extractor 90 for generating a suction force or vacuum sufficient to force the debris 64 through the secondary extractor 90. The separated, cleaned billets 60, heavier than the debris 64 expelled through the primary extractor 66, may then fall from the distal end portion 78 of the elevator 74. In some instances, the billets 60 may fall downwardly through an elevator discharge opening 94 defined by the elevator assembly 62 into an external storage device, such as a sugarcane billet cart.

During operation, the harvester 10 traverses the agricultural field 24 for harvesting sugarcane. After the height of the topper assembly 30 is adjusted via the arms 36, the gathering disk 32 on the topper assembly 30 may function to gather the sugarcane stalks as the harvester 10 proceeds across the field 24, while the cutting disk 34 severs the leafy tops of the sugarcane stalks for disposal along either side of harvester 10. As the stalks enter the harvested material divider 38, the ground shoes 42 may set the operating width to determine the quantity of sugarcane entering the throat of the harvester 10. The spiral feed rollers 40 then gather the stalks into the throat to allow the knock-down roller 44 to bend the stalks downwardly in conjunction with the action of the fin roller 46. Once the stalks are angled downward as shown in FIG. 1, the base cutter assembly 50 may then sever the base of the stalks from field 24. The severed stalks are then, by the movement of the harvester 10, directed to the feed roller assembly 52.

The severed sugarcane stalks are conveyed rearwardly by the bottom and top rollers 54, 56, which compresses the stalks, makes them more uniform, and shakes loose debris 64 to pass through the bottom rollers 54 to the field 24. At the downstream end portion of the feed roller assembly 52, the chopper assembly 58 cuts or chops the compressed sugarcane stalks into pieces or billets 60 (e.g., 6-inch sugarcane sections). The processed harvested material discharged from the chopper assembly 58 is then directed as a stream of billets 60 and debris 64 into the primary extractor 66. The airborne debris 64 (e.g., dust, dirt, leaves, etc.) separated from the billets 60 is then extracted through the primary extractor 66 using suction created by the fan assembly 68. The separated/cleaned billets 60 can then be directed to an elevator hopper 96 into the elevator assembly 62 and travel upwardly via the elevator 74 from its proximal end portion 76 to its distal end portion 78. During normal operation, once the billets 60 reach the distal end portion 78 of the elevator 74, the billets 60 fall through the elevator discharge opening 94 to an external storage device. If provided, the secondary extractor 90 (with the aid of the fan assembly 68) blows out trash/debris 64 from the harvester 10, similar to the primary extractor 66.

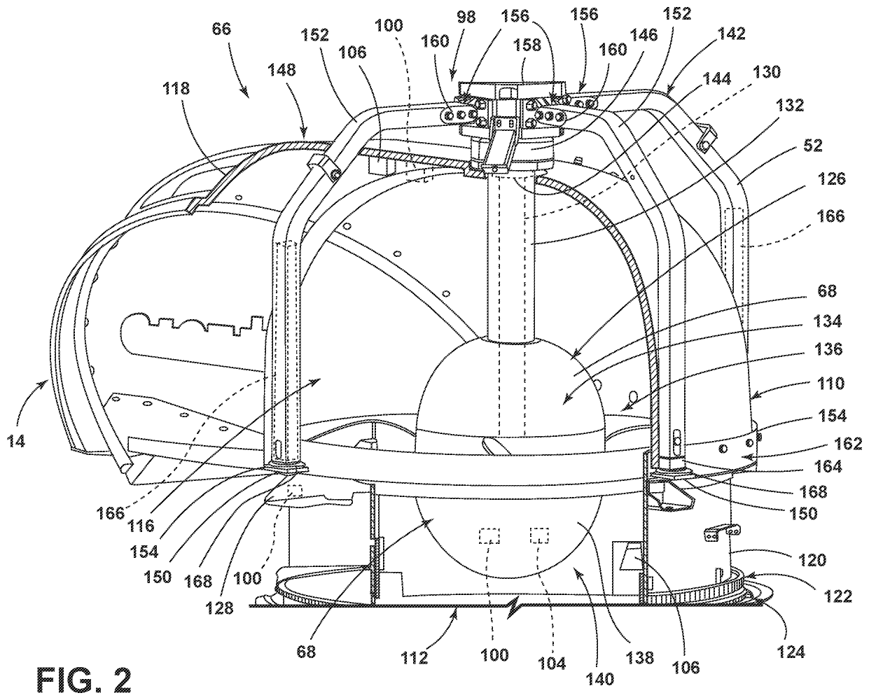

In various examples, the harvester 10 may also include a sensor system 98 including various onboard sensors for monitoring one or more operating parameters or conditions of the harvester 10. For instance, the sensor system 98 may include one or more degradation sensors 100 configured to generate data indicative of one or more conditions of the extractor 66 during operation of the harvester 10 (e.g., objects impacting a hood 118 (FIG. 2) or other components of the extractor 66, an amount of fan vibration, various impact or operating sounds, visual changes to the extractor 66, etc.). Additionally or alternatively, the sensor system 98 may include one or more harvester-performance sensors 102 configured to generate data indicative of a proportion of foliage to crop material. Additionally or alternatively, the sensor system 98 may include one or more fan operation sensors 104 configured to generate data indicative of the operating conditions of the fan assembly 68 within the extractor 66. Additionally or alternatively, the sensor system 98 may include one or more extractor airflow sensors 106 configured to generate data indicative of an airflow metric associated with the extractor 66.

Referring now to FIG. 2, a perspective view of the fan assembly 68 installed within the primary extractor 66 of the harvester 10 is illustrated in accordance with aspects of the present subject matter. In general, the fan assembly 68 will be described herein with reference to being installed within a harvester's primary extractor 66. However, in other embodiments, the disclosed fan assembly 68 may also be installed within a harvester's secondary extractor 90 and operably coupled with any of the components described herein.

As shown in FIG. 2, the extractor 66 may generally include an extractor housing 110 extending from an extractor inlet 112 to an extractor outlet 114. In various examples, an airflow channel 116 may be defined between the extractor inlet 112 and outlet 114 for directing debris 64 (FIG. 1) through the housing 110 for subsequent discharge from the extractor 66 via the outlet 114. As such, debris 64 (FIG. 1) directed into the inlet 112 of the extractor housing 110 may flow through the airflow channel 116 prior to being discharged from the extractor 66 through the extractor outlet 114.

In some examples, the extractor housing 110 may include a hood 118 and a barrel 120 operably coupled with the hood 118. The barrel 120 may be operably coupled with the hood 118 and define an upstream portion of the airflow channel 116 relative to the hood 118. An extractor rotation assembly 122 can be operably coupled with the barrel 120 and an additional component (e.g., an elevator support 124) to allow for the rotation of the barrel 120 and the hood 118 relative to the additional component. As such, the position of the extractor outlet 114 may be altered relative to the chassis (FIG. 1) (and/or any other component) of the harvester 10. For example, as illustrated in FIG. 2, the extractor rotation assembly 122 can include a first engagement section (e.g., teeth) that engages a second engagement section (e.g., corresponding teeth). The second engagement section may be rotated by an adjustment device, which, in turn, can rotate the extractor housing 110 (or portions thereof). In various examples, the adjustment device may be configured as a motor.

Additionally, as shown in FIG. 2, the fan assembly 68 may be positioned within the extractor housing 110. The fan assembly 68 may include a fan hub 126, a plurality of fan blades 128 coupled to and extending radially outwardly from the hub 126, a shaft 130 configured to rotationally drive the hub 126 (and, thus, the fan blades 128), a shaft housing 132 surrounding at least a portion of the shaft 130, an upper hub 134 covering configured to be installed relative to a top or downstream side 136 of the fan hub 126, a lower hub covering 138 configured to be installed relative to a bottom or upstream side 140 of the fan hub 126, and/or a support system 142.

With further reference to FIG. 2, the fan assembly 68 may be installed at least partially within the extractor housing 110 such that the hub 126 and the fan blades 128 are positioned within the airflow channel 116 defined by the housing 110. For example, an upper portion of the shaft 130 and the shaft housing 132 may extend through an opening 144 defined by the extractor housing 110 to allow the various components of the fan assembly 68 to extend into the housing 110. Additionally, a rotational drive source 146, such as a hydraulic motor driven by the vehicle's hydraulic system or any other suitable motor, may be installed proximate to the upper portion 148 of the extractor housing 110 and may be rotationally coupled to the shaft 130. As such, the rotational drive source 146 may rotate the shaft 130, which may, in turn, can rotationally drive the hub 126 and the fan blades 128 to allow the fan assembly 68 to generate a suction force at the extractor inlet 112 that draws debris 64 away from the stream of billets 60 expelled from the chopper assembly 50 (FIG. 1) and into the airflow channel 116 defined by the extractor housing 110 for subsequent delivery to the extractor outlet 114. The cleaned billets 60 may then fall onto the elevator assembly 62 (FIG. 1) for transport to a suitable receiver.

As shown in FIG. 2, the support system 142 can include one or more brackets 150 that may be operably coupled with the barrel 120 (and/or the hood 118) of the extractor housing 110. In some cases, the one or more brackets 150 may be integrally formed with the barrel 120 (and/or the hood 118). Alternatively, the one or more brackets 150 may be attached to the barrel 120 (and/or the hood 118) through the use of any practicable fastening method.

The support structure can further include one or more arms 152 operably coupled with respective brackets 150. For instance, as shown in the illustrated example of FIG. 2, the support system 142 may include three arms 152 each operably coupled with respective brackets 150. However, it will be appreciated that the support structure may include any number of arms 152 operably coupled with respective and/or common brackets 150 without departing from the scope of the present disclosure.

In some cases, each arm 152 may have a first end portion 154 operably coupled with a respective bracket 150 and a second end portion 156 operably coupled to a common unit 158. In some cases, each of the arms 152 may be operably coupled with the common unit 158 through the use of one or more braces 160 and/or one or more fasteners operably coupled with the one or more braces 160 and/or the respective arm 152. In various examples, the one or more braces 160 may allow for rotational movement of the arm 152 relative to the common unit 158. As shown in FIG. 2, the one or more braces 160 may operably couple each of the arms 152 to a side portion of the common unit 158. However, it will be appreciated that the one or more braces 160 may couple the arms 152 to any other portion of the common unit 158 without departing from the teachings provided herein. Additionally, it will be appreciated that any of the arms 152 may be operably coupled to the common unit 158 without the use of braces 160 and/or fasteners. Further, in some cases, the arms 152 may operably couple to one another without the use of a common unit 158 without departing from the scope of the present disclosure.

Referring still to FIG. 2, in several examples, the rotational drive source 146 may be operably coupled with the common unit 158. For instance, as shown in FIG. 2, the rotational drive source 146 may be operably coupled with a bottom section of the common unit 158 such that the rotational drive source 146 is positioned at least partially above the opening 144 defined by the hood 118. The shaft 130 and/or the shaft housing 132 surrounding at least a portion of the shaft 130 may be positioned on an opposing side of the rotational drive source 146 from the common unit 158. As such, the opening 144 defined by the hood 118, the rotational drive source 146, the shaft 130, and/or the shaft 130 housing may be at least partially aligned with the common unit 158 relative to a y-axis direction. In some examples, a seal may be positioned between the shaft housing 132 and the hood 118 within the opening 144.

As provided herein, the harvester 10 may also include a sensor system 98 including various onboard sensors for monitoring one or more operating parameters or conditions of the harvester 10. For instance, the sensor system 98 may include one or more degradation sensors 100 configured to generate data indicative of one or more conditions of the extractor 66 during operation of the harvester 10 (e.g., objects impacting the hood 118 or other components of the extractor 66, an amount of fan vibration, various impact or operating sounds, visual changes to the extractor 66, etc.). Additionally or alternatively, the sensor system 98 may include one or more harvester-performance sensors 102 configured to generate data indicative of a proportion of foliage to crop material. Additionally or alternatively, the sensor system 98 may include one or more fan operation sensors 104 configured to generate data indicative of the operating conditions of the fan assembly 68 within the extractor 66. Additionally or alternatively, the sensor system 98 may include one or more extractor airflow sensors 106 configured to generate data indicative of an airflow metric associated with the extractor 66.

The one or more degradation sensors 100 can include any sensor capable of detecting objects impacting the hood 118 or other components of the extractor 66. For example, the one or more degradation sensors 100 may be configured as an Inertial Measurement Unit (IMU) operatively associated with one or more components of the extractor 66 (e.g., the hood 118, the fan assembly 68, the fan blades 128 of the fan assembly 68, etc.) that utilizes any combination of accelerometers, gyroscopes, magnetometers, and/or any other practicable device to generate data indicative of acceleration peaks of the component of the extractor 66 due to harvested material impacting the component. Additionally or alternatively, the one or more degradation sensors 100 may be configured as a sound sensor operatively associated with one or more components of the extractor 66 (e.g., the hood 118, the fan assembly 68, the fan blades 128 of the fan assembly 68, etc.) that receives an acoustic wave and generates data indicative of the sound. Additionally or alternatively, the one or more degradation sensors 100 may be configured as a vision-based sensor, such as a camera, radar sensor, ultrasound sensor, LIDAR device, another vision-based sensor, etc., that captures sensor data indicative of one or more observable conditions or parameters associated with the component of the harvester 10.

The one or more harvester-performance sensors 102 can include any sensor configured to generate data indicative of a harvest-related parameter, such as a proportion of foliage to crop material or any other harvest-related parameter. For instance, the one or more harvester-performance sensors 102 may be configured as various speed sensors for monitoring the speed of the harvester 10, and/or the operating speed of one or more components of the harvester 10. In several embodiments, the speed sensors may be used to detect or monitor various different speed-related parameters associated with the harvester 10, including, but not limited to, the ground speed of the harvester 10, the engine speed of the harvester's engine (e.g., engine RPM), the elevator speed of the elevator assembly 62, the rotational speed of the fan blades 128 of the base cutter assembly 50, the rotational speed of the chopper assembly 58, the rotational speed of the rollers 54, 56 of the feed roller assembly 52, the fan speed associated with the primary extractor 66 and/or the secondary extractor 90, and/or any other suitable operating speeds associated with the harvester 10.

In several embodiments, the one or more harvester-performance sensors 102 can include one or more position sensors used to monitor one or more corresponding position-related parameters associated with the harvester 10. The one or more position sensors may be configured as an Inertial Measurement Unit (IMU) to generate data indicative of a body's specific force, angular rate, and/or magnetic field surrounding the body, using any combination of accelerometers, gyroscopes, magnetometers, and/or any other practicable device. Additionally or alternatively, the one or more harvester-performance sensors 102 may include one or more vision-based sensors (e.g., one or more cameras, radar sensors, ultrasound sensors, LIDAR devices, another vision-based sensor, etc.) used to capture sensor data indicative of a position of a component of the harvester 10. Position-related parameters that may be monitored via the position sensor(s) include, but are not limited to, the cutting height of the base cutter assembly 50, the relative positioning of the bottom and top rollers 54, 56 of the feed roller assembly 52 (e.g., as will be described below with reference to FIG. 2), the vertical travel or position of the chassis or frame 12 of the harvester 10, and/or any other suitable position-related parameters associated with the harvester 10.

Moreover, in several embodiments, the one or more harvester-performance sensors 102 may include or incorporate one or more pressure sensors used to monitor one or more corresponding pressure-related conditions or parameters associated with the harvester 10. For instance, pressure-related conditions or parameters that may be monitored via the pressure sensor(s) include, but are not limited to, the fluid pressures associated with the hydraulic fluid supplied to one or more hydraulic components of the harvester 10, such as a hydraulic motor rotationally driving the base cutter assembly 50 (e.g., the base cutter pressure), a hydraulic motor rotationally driving the feed roller assembly 50, a hydraulic motor rotationally driving the chopper assembly 58, a hydraulic motor rotationally driving the fan assembly 68 of the primary extractor 66, a hydraulic motor rotationally driving the elevator assembly 62, a hydraulic motor rotationally driving the secondary extractor 90, and/or any other suitable pressure-related conditions or parameters associated with the harvester 10.

In some embodiments, the one or more harvester-performance sensors 102 may include or incorporate one or more load sensors (e.g., one or more load cells or sensorized load plates) used to monitor one or more corresponding load-related conditions or parameters associated with the harvester 10. For instance, as shown in FIG. 1, one or more load sensors may be provided in operative association with the elevator assembly 62 to allow the weight or mass flow rate of the harvested material being directed through the elevator 74 to be monitored.

Additionally, in some embodiments, the one or more harvester-performance sensors 102 may include or incorporate vision-based material sensors (e.g., one or more cameras, radar sensors, ultrasound sensors, LIDAR devices, another vision-based sensor, etc.) used to capture sensor data indicative of one or more observable conditions or parameters associated with the harvester 10, such as by providing a camera or LIDAR device to allow the potential upcoming harvested material mass within the field 24 to be estimated based on the received vision-based data or by providing an internally installed camera or radar device to allow sensor data to be captured that is associated with the current foliage ratio of the harvested material at the elevator 74 and/or within any of location of the harvester 10 and/or the mass flow of the harvested material through the harvested material processing system 28. For instance, as shown in FIG. 1, a forward looking harvest material sensor may be installed on the cab 18 with a field of view directed in front of the harvester 10 to allow images or other vision-based data to be captured that indicates the upcoming harvested material mass within the field 24. Additionally or alternatively, as shown in FIG. 1, a harvest material sensor may be installed proximate to the knock-down roller 44 with a field of view directed towards an infeed location of the harvested material entering the harvester 10 to allow images or other vision-based data to be captured that indicates the upcoming harvested material mass within the field 24. Additionally or alternatively, as shown in FIG. 1, one or more harvest material sensors may be installed proximate to the elevator housing 72 with a field of view directed towards the elevator 74 to allow images or other vision-based data to be captured that provides an indication of the debris 64 and/or stalks, or billets 60, (i.e., current foliage ratio) downstream of the primary extractor 66. It will be appreciated that the one or more harvester-performance sensors 102 may also include various other sensors or sensing devices.

With further reference to FIG. 2, in several examples, the one or more fan operation sensors 104 can include any sensor that is configured to generate data indicative of the operating conditions of the fan assembly 68 within the extractor 66. For example, the one or more fan operation sensors 104 can include a speed sensor configured to generate indicative of the fan blade speed (e.g., RPM). Additionally or alternatively, the one or more fan operation sensors 104 can include a pressure sensor configured to generate data indicative of pressure-related conditions or parameters associated with the fan assembly 68. For instance, pressure-related conditions or parameters that may be monitored via the pressure sensor(s) can include the fluid pressure associated with the hydraulic fluid supplied to a hydraulic motor rotationally driving the fan blades 128 of the primary extractor 66. Additionally or alternatively, the one or more fan operation sensors 104 can include a position sensor to allow a position of one or more components of the fan assembly 68 to be determined relative to another component of the harvester 10. The position sensor may be configured as an Inertial Measurement Unit (IMU) to generate data indicative of a body's specific force, angular rate, and/or magnetic field surrounding the body, using any combination of accelerometers, gyroscopes, magnetometers, and/or any other practicable device. Additionally or alternatively, the position sensor may include one or more vision-based sensors (e.g., one or more cameras, radar sensors, ultrasound sensors, LIDAR devices, another vision-based sensor, etc.) used to capture sensor data indicative of a position of a component of the harvester 10.

In various examples, the one or more extractor airflow sensors 106 can include any sensor configured to generate data indicative of an airflow metric associated with the extractor 66. For example, the one or more extractor airflow sensors 106 can include a first pressure sensor may be configured to measure fluid pressure on a first side of the fan blades 128 of the fan assembly 68. A second pressure sensor may be spaced from the first pressure sensor at a known distance and configured to measure fluid pressure on a second opposing side of the fan blades 128 of the fan assembly 68. In some cases, when the extractor 66 is free of harvested material (which may be detected by a vision-based sensor assembly), a pressure relationship between air pressures as detected by the first pressure sensor and the second pressure sensor may be determined. In turn, the pressure relationship may be used to determine a pressure differential created by the fan assembly 68. In various examples, the pressure sensors may be configured as fiber optic sensors, mechanical deflection sensors, piezoelectric sensors, microelectromechanical system (MEMS) sensors, or any other suitable sensor configured to output a signal indicative of fluid pressure.

Additionally or alternatively, the one or more extractor airflow sensors 106 may include an airspeed sensor, such as an anemometer and/or any other practicable device, which may be configured to generate data indicative of an airspeed (or an airflow) within the extractor housing 110.

Referring now to FIGS. 2-5, the support system 142 may further include an adjustment assembly 162 that is configured to alter a position of the fan blades 128 relative to the hood 118, the barrel 120, and/or any other component of the harvester 10. The adjustment assembly 162 may allow the distance between the fan blades 128 (and/or the fan hub 126) and the material flow to be cleaned within the airflow channel 116 to be altered, which can affect the operational efficiency of the extractor 66 due to variations in turbulence, airflow, and material impact within the extractor 66. For example, when the material to be cleaned is located too close to the fan blades 128 (and/or the fan hub 126), turbulence in the airflow can be generated by the fan assembly 68. The turbulence can disrupt the flow of air, reducing the cleaning efficiency, increasing the energy consumption, and/or decreasing the lifespan of the extractor 66. Alternatively, if the distance between the fan blades 128 (and/or the fan hub 126) and the material to be cleaned is too far, the airspeed can decrease, which can reduce the transport capacity of particles due to a decrease in suction force. the reduction of the transport capacity of particles can lead to less air being able to be pulled into the extractor housing 110, which, in turn, can result in less efficient cleaning of the material. Furthermore, if the material to be cleaned is located too close to the fan blades 128 (and/or the fan hub 126) to allow too much material to hit the fan blades 128 (and/or the fan hub 126), unnecessary damage, wear, and stress may be created on the fan blades 128 (and/or the fan hub 126), which can lead to premature equipment failure. Therefore, the adjustment assembly 162 can alter a distance between the material to be cleaned and the fan blades 128 (and/or the fan hub 126) to reduce turbulence and/or increase an efficiency of the harvesting operation. It will be appreciated that a defined distance of the fan relative to the inlet, the hood 118, and/or any other component may vary depending on multiple variables.

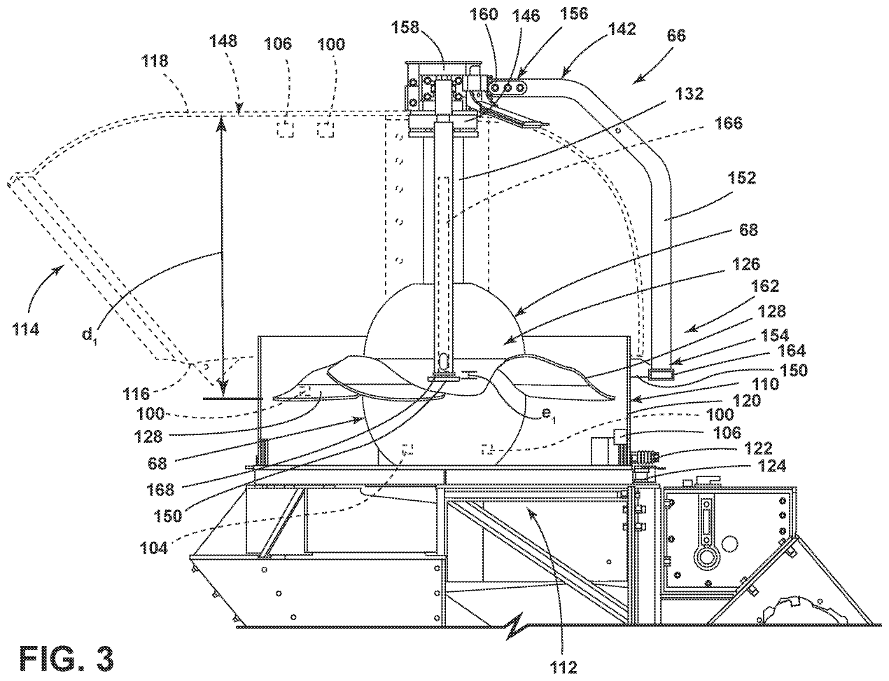

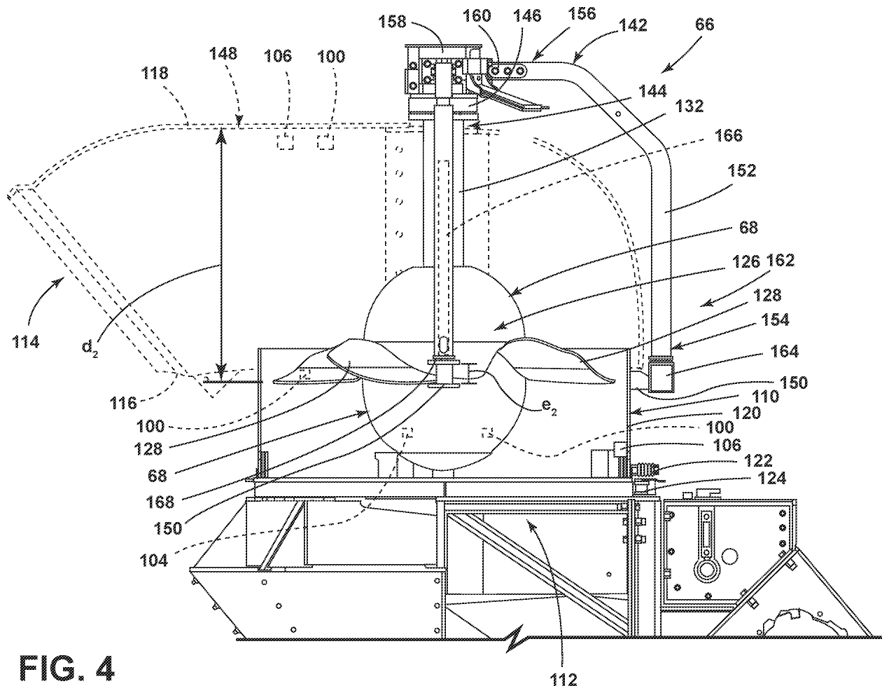

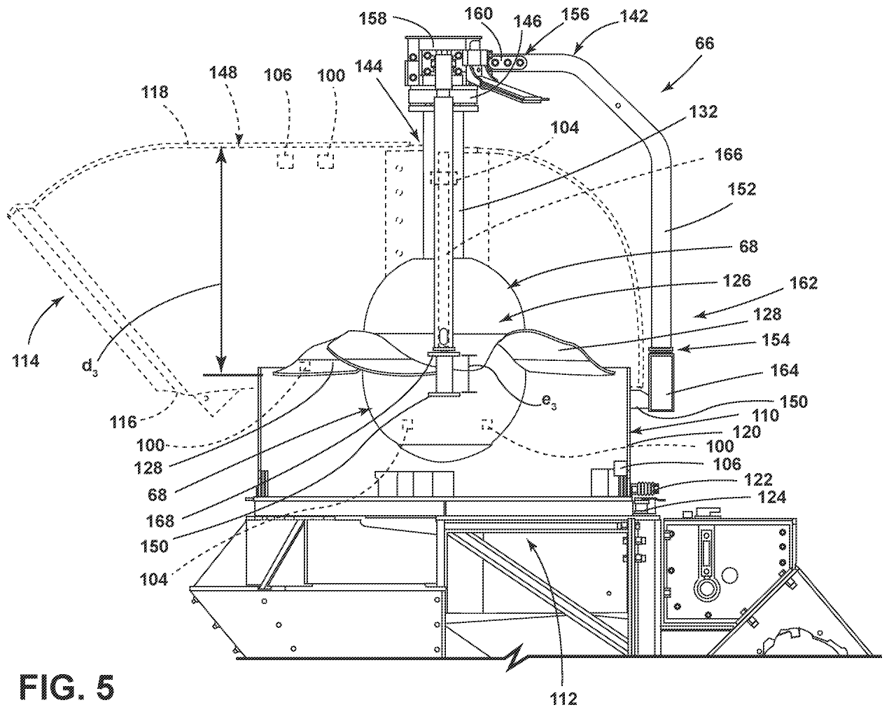

As illustrated, the adjustment assembly 162 can include an actuator 164 operably coupled with an arm 152 of the support system 142. In some examples, the actuator 164 may be operably coupled between the bracket 150 and the first end portion 154 of the arm 152. As such, the actuator 164 may alter a position of the first end portion 154 of the arm 152 relative to the bracket 150 as the actuator 164 is moved from a first position, such as that illustrated in FIG. 3, to a second position, such as that illustrated in FIG. 4, and/or to a third position, such as that illustrated in FIG. 5. As will be described in greater detail below, the actuator 164 may be configured as an electrically-powered actuator, a pneumatic actuator, a hydraulic actuator, a delta drive, or any other practicable device.

In some examples, such as those provided in FIGS. 2-5, the adjustment assembly 162 may further include a guide 166 that is operatively associated with one or more arms 152 of the support system 142. For example, the guide 166 may be positioned within one or more of the arms 152 and allows for the arm 152 to slide there along to support and/or guide the arm 152 as the actuator 164 alters a position of the arms 152 relative to the hood 118, the barrel 120, and/or any other component of the harvester 10. In various examples, the guide 166 may be positioned externally of the one or more arms 152 and/or otherwise operably coupled with the components of the support system 142 to assist in moving the arms 152 along a defined path. In some cases, an actuator 164 may be operably coupled with a first arm 152 of the support system 142 and the guide 166 may be operably coupled with a second arm 152 (and/or a third arm 152). Alternatively, the guide 166 may be operably coupled with each of the arms 152.

With further reference to FIGS. 2-5, in various examples, a standoff 168 may be positioned between the first end portion 154 of the arm 152 and the bracket 150 (and/or the actuator 164) to reduce any NVH (Noise Vibration Harshness) and BSR (Buzz Squeak Rattle) during the use of the harvester 10. The standoff 168 may be configured as a resilient material, damper, or other practicable material.

Referring further to FIGS. 3-5, when the actuator 164 is in the first position, as shown in FIG. 3, an upstream portion of the one or more fan blades 128 may be a first offset distance d₁ from the upper portion 148 of the hood 118. In addition, one or more arms 152 that are operatively associated with the guide 166 may also be in a first location relative to the guide 166 with the first end portion 154 of the arm 152 located at a first extension distance e₁ from the bracket 150.

When the actuator 164 is in the second position, as shown in FIG. 4, an upstream portion of the one or more fan blades 128 may be a second offset distance d₂ from the upper portion 148 of the hood 118. As illustrated, the second offset distance d₂ may be less than the first offset distance d₁. In addition, one or more arms 152 that are operatively associated with the guide 166 may also be in a second location relative to the guide 166 with the first end portion 154 of the arm 152 located at a second extension distance e₂ from the bracket 150. As illustrated, the second extension distance e₂ may be greater than the first extension distance e₁.

When the actuator 164 is in the third position, as shown in FIG. 5, an upstream portion of the one or more fan blades 128 may be a third offset distance d₃ from the upper portion 148 of the hood 118. As illustrated, the third offset distance de may be less than the first offset distance d₁, and/or the second offset distance d₂. In addition, one or more arms 152 that are operatively associated with the guide 166 may also be in a third location relative to the guide 166 with the first end portion 154 of the arm 152 located at a third extension distance e₃ from the bracket 150. As illustrated, the third extension distance e₃ may be greater than the first extension distance e₁, and/or the second extension distance e₂.

With the fan blades 128 and/or the hub 126 placed in various positions relative to the hood 118 and/or the airflow channel 116, the turbulence, airflow, and material impact within the extractor 66 may be varied. While the positions are described with regards to the position of an upstream portion of the fan blades 128 relative to the upper portion 148 of the hood 118, it will be understood that a position of any component of the fan assembly 68 may be altered through actuation of the actuator 164 without departing from the teachings provided herein.

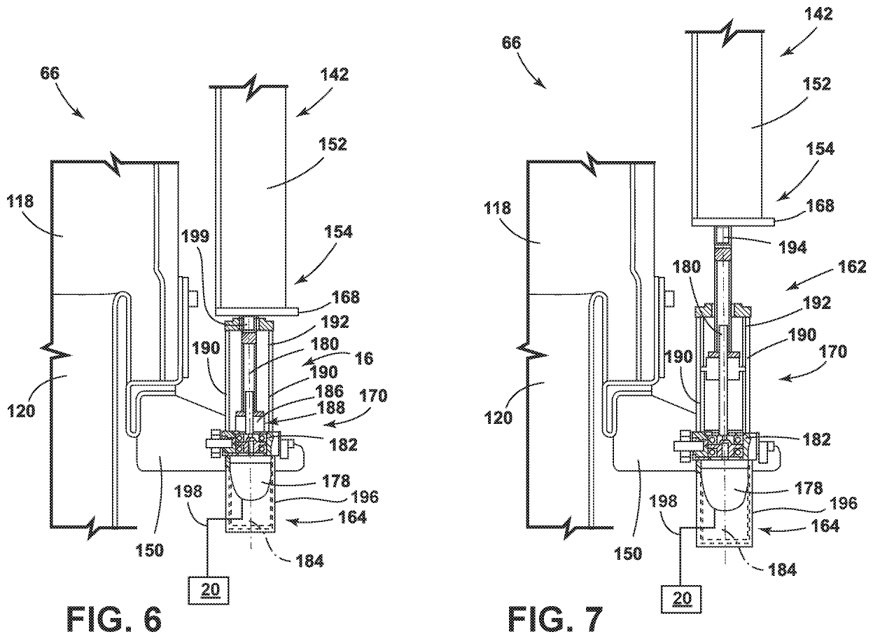

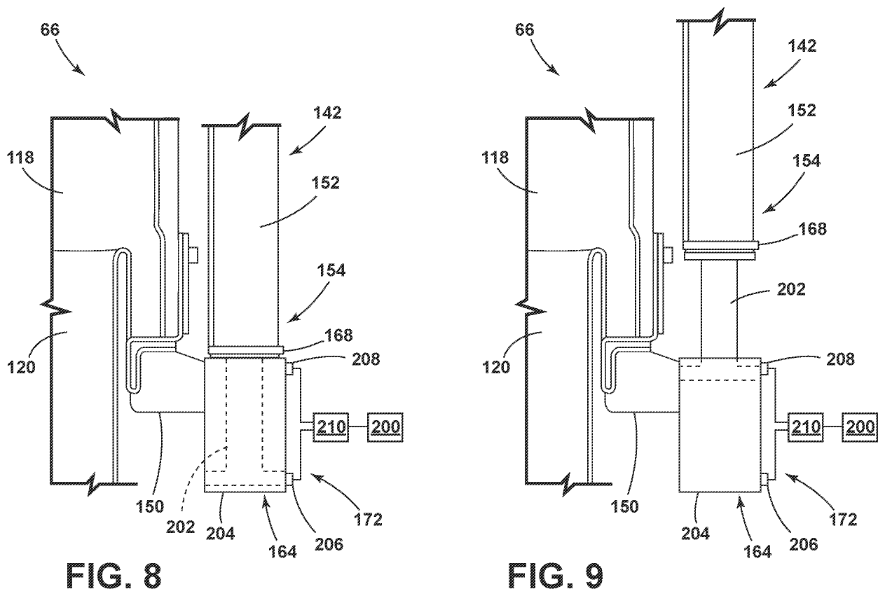

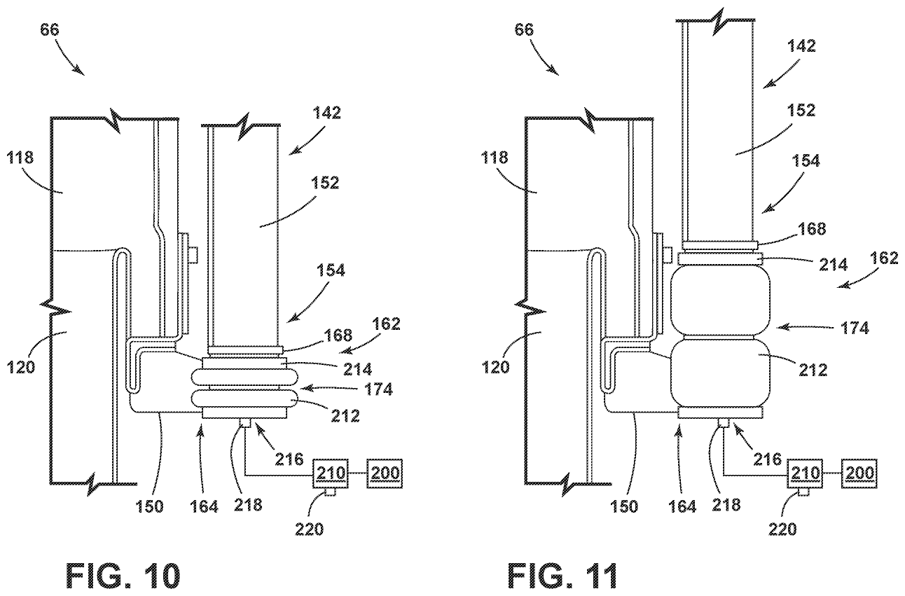

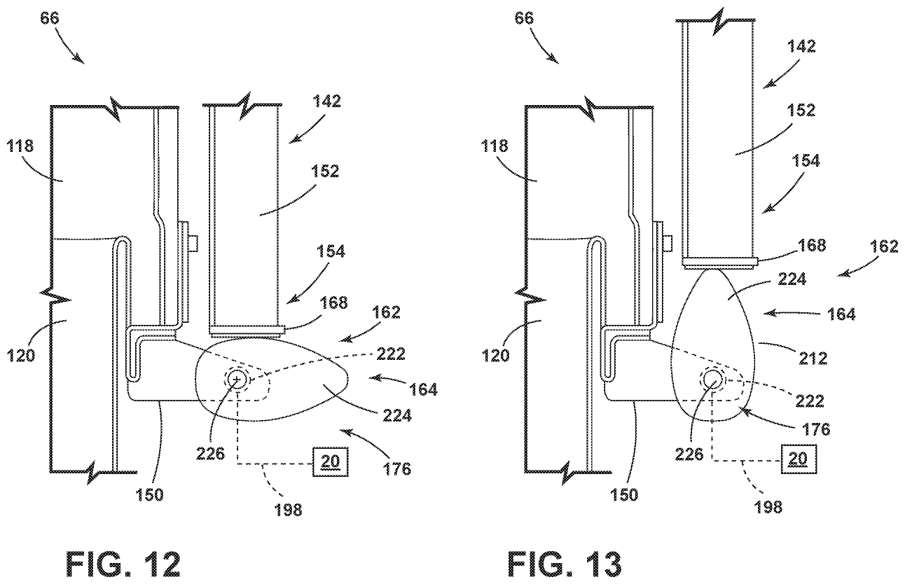

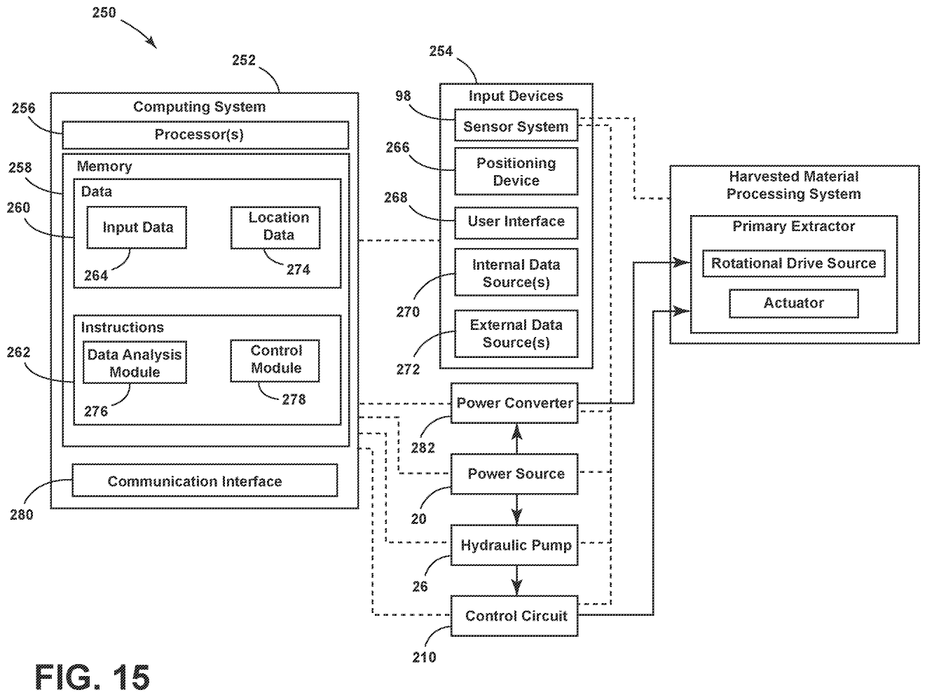

Referring now to FIGS. 6-11, in various examples, the actuator 164 may be configured as an electrically-powered actuator 170 (FIGS. 6 and 7), a cylinder 172 (FIGS. 8 and 9), an airbag actuator 174 (FIGS. 10 and 11), a cam-based actuator 176 (FIGS. 12 and 13), and/or any other practicable device for moving one or more arms 152 of the support system 142 between various positions. In any manner, the actuator 164 may be operably coupled with a computing system 252 (FIG. 15) that is configured to actuate the actuator 164 to alter the position of the fan assembly 68 relative to the hood 118 (and/or any other component of the harvester 10). Moreover, the actuator 164 may be manually operated through adjustment by an operator.

As shown in FIGS. 6 and 7, the actuator 164 may be configured as a linear actuator 164 with an electrically-powered motor 178. In the illustrated example, a screw 180 is supported by a support block 182 and rotates about a screw axis 184. The motor 178 can be operably coupled with the support block 182. The screw 180 may be configured as a ball screw, and a nut 186 may be engaged to the screw 180. The nut may have one or more pins 188 engaging with a guide groove 190 that is defined by a cylinder cover 192 and is parallel to the screw axis 184. Consequently, the nut 186 moves linearly corresponding to a rotation of the screw 180. An output shaft 194 may be connected to the nut 186 and is guided by a bearing held in an end cup. In some cases, the motor 178 can be covered by a motor cover 196 for keeping out dust and water. An electrical wiring 198 for driving the motor can be operably coupled with a power source 20.

Additionally or alternatively, as shown in FIGS. 8 and 9, the actuator 164 may be configured as a cylinder 172 configured to move an arm 152 of the support assembly between a first position and a second position through the actuation of the actuator 164. The cylinder 172 may be a single or dual-action cylinder that is responsive to a fluid in a reservoir 200, such as an oil (hydraulic) or gas (pneumatic). The cylinder 172 can include a piston rod 202 configured to extend and retract with respect to a base 204. The cylinder 172 can include a base port 206 and a rod port 208. Fluid from a control circuit 210 fluidly coupled with a reservoir 200 entering the base port 206 (and exiting the rod port 208) causes the piston rod 202 to extend, and fluid from the reservoir 200 entering the rod port 208 (and exiting the base port 206) causes the piston rod 202 to retract.

Additionally or alternatively, as shown in FIGS. 10 and 11, the actuator 164 may be configured as an airbag actuator 174 that includes a selectively inflatable elastically-deformable bladder 212, a top plate 214, and/or a bottom plate 216. In some examples, the airbag actuator 174 can include a port 218 operably coupled with a control circuit 210 and a reservoir 200. A fluid from the control circuit 210 enters the port 218 to cause the bladder 212 to inflate, and fluid from the bladder 212 enters the control circuit 210 to cause the bladder 212 to retract. In some cases, the fluid may be transferred to and from the bladder 212 through the control circuit 210 and may be received from the reservoir 200. Additionally or alternatively, the fluid may be transferred to and from the bladder 212 through a port 220 within the control circuit 210 to allow for the usage of ambient air within the bladder 212.

As shown in FIGS. 12 and 13, the actuator 164 may be configured as a cam-based actuator 176 with an electrically-powered motor 222. In the illustrated example, a cam 224 is rotatably coupled with the bracket 150 (and/or any other component) and rotates about a rotational axis 226. The motor 178 can be operably coupled with the cam 224 and the bracket 150. The cam 224 can be non-circular. As such, when the cam 224 is placed in a first position (e.g., as shown in FIG. 12), the arm 152 may be in a first position and when the cam 224 is placed in a second position, (e.g., as shown in FIG. 13), the arm 152 may be in a second position. An electrical wiring 198 for driving the motor 222 can be operably coupled with a power source 20.

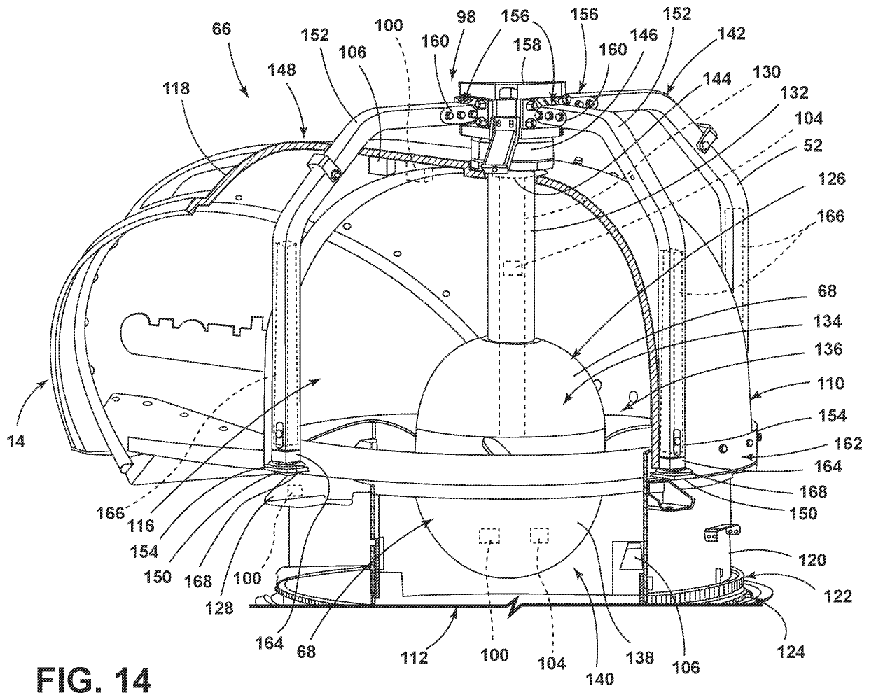

Referring now to FIG. 14, in some examples, the adjustment assembly 162 can include more than one arm 152 that may be operably coupled with a respective actuator 164. As provided herein, each actuator 164 may be operably coupled between the bracket 150 and the first end portion 154 of each respective arm 152. As such, the actuators 164 may alter a position of each respective first end portion 154 relative to each respective bracket 150. It will be appreciated that the actuators 164 may be additionally or alternatively located in any other location and operably coupled with the support system 142 without departing from the teachings provided herein. Furthermore, as described herein, each of the actuators 164 may be configured as an electrically-powered actuator, a pneumatic actuator, a hydraulic actuator, a delta drive, or any other practicable device.

Additionally or alternatively, the adjustment assembly 162 may further include a guide 166 operatively associated with the one or more arms 152 of the support system 142 that is also operably coupled with an actuator 164. For example, each of the guides 166 may be positioned within one or more of the arms 152 that is further coupled with an actuator 164 and allows for the arm 152 to slide there along to support and/or guide the arm 152 as the actuator 164 alters a position of the arm 152 relative to the hood 118, the barrel 120, and/or any other component of the harvester 10. In various examples, the guide 166 may be positioned externally of the one or more arms 152 and/or otherwise operably coupled with the components of the support system 142 to assist in moving the arms 152 along a defined path.

Referring now to FIG. 15, a schematic view of a system 250 is illustrated in accordance with aspects of the present subject matter. In general, the system 250 will be described herein with reference to the harvester 10 described above with reference to FIGS. 1-14. However, it will be appreciated that the disclosed system 250 may generally be utilized with harvesters having any suitable harvester configuration.

In several embodiments, the system 250 may include a computing system 252 and various other components configured to be communicatively coupled to and/or controlled by the computing system 252, such as various input devices 254 and/or various components of the harvester 10. In some embodiments, the computing system 252 is physically coupled to the harvester 10. In other embodiments, the computing system 252 is not physically coupled to the harvester 10 (e.g., the computing system 252 may be remotely located from the harvester 10) and instead may communicate with the harvester 10 over a wireless network.

In general, the computing system 252 may correspond to any suitable processor-based device(s), such as a computing device or any combination of computing devices. For example, the computing system 252 may generally include one or more processor(s) 256 and associated memory devices 258 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 258 may generally include memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 258 may generally be configured to store information accessible to the processor(s) 256, including data 260 that can be retrieved, manipulated, created, and/or stored by the processor(s) 256 and instructions 262 that can be executed by the processor(s) 256.

In several embodiments, the data 260 may be stored in one or more databases. For example, the memory 258 may include an input database 264 for storing input data received from the input device(s) 254. For example, the input device(s) 254 may include the sensor system 98, which includes one or more sensors configured to monitor one or more conditions associated with the harvester 10 and/or the operation being performed therewith (e.g., including one or more of the various sensors, described above), one or more positioning device(s) 266 for generating position data associated with the location of the harvester 10, one or more user interfaces 268 for allowing operator inputs to be provided to the computing system 252 (e.g., buttons, knobs, dials, levers, joysticks, touch screens, and/or the like), one or more other internal data sources 270 associated with the harvester 10 (e.g., other devices, databases, etc.), one or more external data sources 272 (e.g., a remote computing device or server), and/or any other suitable input device(s) 254. The data received from the input device(s) 254 may, for example, be stored within the input database 264 for subsequent processing and/or analysis.

In several embodiments, the computing system 252 may be configured to receive data from the input device(s) 254 that is associated with one or more one or more operating parameters or conditions of the extractor 66. The current one or more operating parameters or conditions of the extractor 66 may, for example, be: based directly or indirectly on sensor data received from the sensor system 98 and/or the location data received from the positioning device(s) 266; calculated or determined by the computing system 252 based on any data accessible to the system 250 (e.g., including data accessed, received, or transmitted from internal data sources 270 and/or external data sources 272); received from the operator (e.g., via the user interface 268); and/or the like.

It will be appreciated that, in addition to being considered an input device(s) that allows an operator to provide inputs to the computing system 252, the user interface 268 may also function as an output device. For example, the user interface 268 may be configured to allow the computing system 252 to provide feedback to the operator (e.g., visual feedback via a display or other presentation device, audio feedback via a speaker or other audio output device, and/or the like).

Moreover, in several embodiments, the memory 258 may also include a location database 274 storing location information about the harvester 10 and/or information about the field 24 being processed (e.g., a field map). Such location database 274 may, for example, correspond to a separate database or may form part of the input database 264. As shown in FIG. 15, the computing system 252 may be communicatively coupled to the positioning device(s) 266 installed on or within the harvester 10. For example, in some embodiments, the positioning device(s) 266 may be configured to determine the exact location of the harvester 10 using a satellite navigation position system (e.g., a GPS, a Galileo positioning system, the Global Navigation satellite system (GLONASS), the BeiDou Satellite Navigation and Positioning system, and/or the like). In such an embodiment, the location determined by the positioning device(s) 266 may be transmitted to the computing system 252 (e.g., in the form of coordinates) and subsequently stored within the location database 274 for subsequent processing and/or analysis.

Additionally, in several embodiments, the location data stored within the location database 274 may also be correlated to all or a portion of the input data stored within the input database 264. For instance, in some embodiments, the location coordinates derived from the positioning device(s) 266 and the data received from the input device(s) 254 may both be time-stamped. In such an embodiment, the time-stamped data may allow the data received from the input device(s) 254 to be matched or correlated to a corresponding set of location coordinates received from the positioning device(s) 266, thereby allowing the precise location of the portion of the field 24 associated with the input data to be known (or at least capable of calculation) by the computing system 252.

Moreover, by matching the input data to a corresponding set of location coordinates, the computing system 252 may also be configured to generate or update a corresponding field map associated with the field 24 being processed. For example, in instances in which the computing system 252 already includes a field map stored within its memory 258 that includes location coordinates associated with various points across the field 24, the input data received from the input device(s) 254 may be mapped or correlated to a given location within the field map. Alternatively, based on the location data and the associated image data, the computing system 252 may be configured to generate a field map for the field 24 that includes the geo-located input data associated therewith.

Referring still to FIG. 15, in several embodiments, the instructions 262 stored within the memory 258 of the computing system 252 may be executed by the processor(s) 256 to implement a data analysis module 276. In general, the data analysis module 276 may be configured to analyze the input data (e.g., a set of input data received at a given time or within a given time period or a subset of the data, which may be determined through a pre-processing method) to determine the current one or more operating parameters or conditions of the extractor 66 with one or more operation models using any algorithm. In various examples, the data analysis module 276 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system 252 and may be used to generate subsequent instructions. For instance, the data analysis module 276 may receive the analyze the input data. In turn, the system may monitor any changes to the current one or more operating parameters or conditions of the extractor 66. Each change may be fed back into the data analysis module 276 for use in the generation of subsequent instructions.

Referring still to FIG. 15, the instructions 262 stored within the memory 258 of the computing system 252 may also be executed by the processor(s) 256 to implement a control module 278. In general, the control module 278 may be configured to adjust the operation of the harvester 10 by controlling one or more components of the harvester 10. In several embodiments, the control module 278 may be configured to automatically control the operation of one or more harvester components based at least in part on the current one or more operating parameters or conditions of the extractor 66 determined as a function of the input data.

For example, the system 250 may be configured to determine a current one or more operating parameters or conditions of the extractor 66 using a model, which may be a machine-learned model. The system 250 may compare the current one or more operating parameters or conditions of the extractor 66 to a defined condition range. In turn, the system 250 may utilize the model to determine an operational setpoint (e.g., a fan position within the hood 118, a fan speed, etc.) of the primary extractor 66 based on a deviation between the current one or more operating parameters or conditions of the extractor 66 and the defined condition range. In addition, the system 250 may utilize a model, which may be a machine-learned model, to determine upcoming characteristics of harvested material (e.g., an amount, a change in the amount of stalk/debris ratio, any additional debris 64 in the field, etc.) at the infeed of the harvester 10 and determine whether an operational setpoint (e.g., a fan position within the hood 118, a fan speed, etc.) of the primary extractor 66 should remain constant or be altered. The system 250 may further monitor a load on the power source 20 and alter the one or more operating parameters or conditions of the extractor 66 of the primary extractor 66 speed if the load is greater than a predefined threshold. Further, the system 250 can monitor a chopper's hydraulic pressure and the machine's ground speed to compensate for the change in the amount of harvested material being processed by the harvester 10.

In some cases, when the actuator 164 is electrically-powered, the power source 20 may be operably coupled with a power converter 282, such as a generator, that, in turn, supplies power to the actuator 164. Additionally or alternatively, the power source 20 may be operably coupled with a hydraulic pump 26 and/or a control circuit 210 which can control the operation of the actuator 164.

In several embodiments, the computing system 252 may also automatically control the operation of the user interface 268 to provide an operator notification associated with the determined one or more operating parameters or conditions of the extractor 66. For instance, in some embodiments, the computing system 252 may control the operation of the user interface 268 in a manner that causes data associated with the determined one or more operating parameters or conditions of the extractor 66 to be presented to the operator of the harvester 10, such as by presenting raw or processed data associated with the one or more operating parameters or conditions of the extractor 66 including numerical values, graphs, maps, and/or any other suitable visual indicators.

Moreover, as shown in FIG. 15, the computing system 252 may also include a communications interface 280 to communicate with any of the various other system components described herein. For instance, one or more communicative links or interfaces (e.g., one or more data buses and/or wireless connections) may be provided between the communications interface 280 and the input device(s) 254 to allow data transmitted from the input device(s) 254 to be received by the computing system 252. Additionally, as shown in FIG. 15, one or more communicative links or interfaces (e.g., one or more data buses and/or wireless connections) may be provided between the communications interface 280 and one or more electronically controlled components of the harvester 10 to allow the computing system 252 to control the operation of such system components.

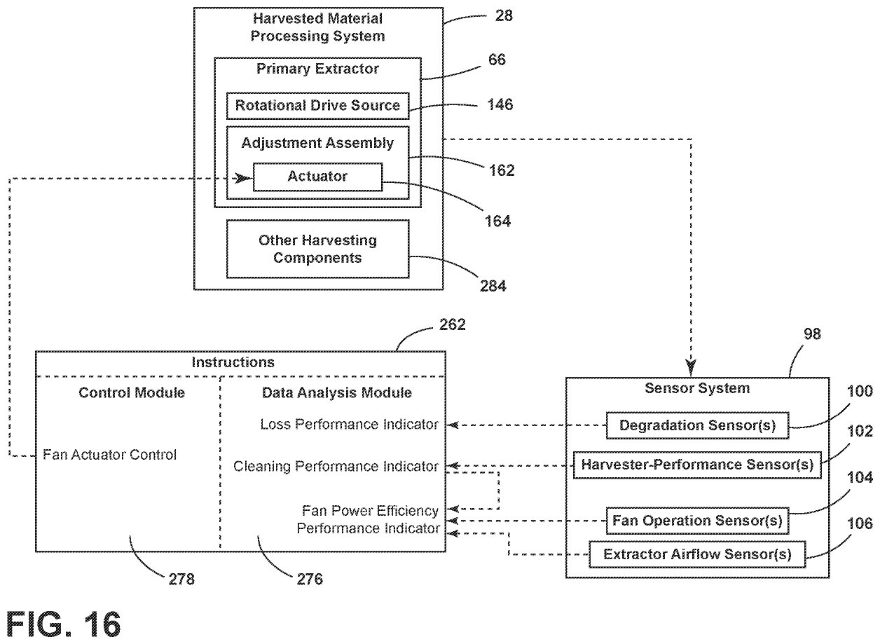

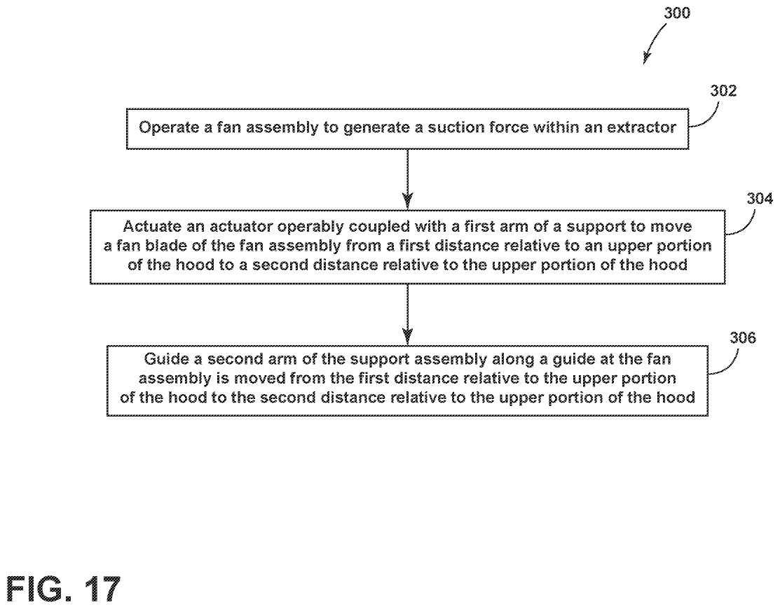

Referring to FIG. 16, various components of the system 250 are illustrated in accordance with various aspects of the present disclosure. As shown, the data analysis module 276 may receive data from various components of the system 250, such as via one or more sensors, and, in turn, the control module 278 can alter or manipulate the various components, such as the actuator 164.

As illustrated, the sensor system 98 can include various onboard sensors for monitoring one or more operating parameters or conditions of the harvester 10. An adjustment assembly 162 that is configured to alter a position of the fan blades 128 relative to the hood 118, the barrel 120, and/or any other component of the harvester 10 may be actuated at least partially based on the data generated by the various onboard sensors. In various examples, the operational efficiency of the extractor 66 may be altered based on the position of the fan blades 128 within the extractor 66 due to variations in turbulence, airflow, material impact within the extractor 66, and/or any other factors.

In some examples, the sensor system 98 may include one or more degradation sensors 100 configured to generate data indicative of one or more conditions of the extractor 66 during the operation of the harvester 10 (e.g., objects impacting the hood 118 or other components of the extractor 66, an amount of fan vibration, various impact or operating sounds, visual changes to the extractor 66, etc.). In some cases, the data analysis module 276 may determine a loss performance indicator based at least in part on the data provided by the one or more degradation sensors 100. As used herein, the loss performance indicator may be representative of a loss related to a high drag coefficient created by the fan that extracts millable billets 60 that then are shattered passing through the fan blades 128. In some instances, decreasing a distance between the fan blades 128 and an upper portion 148 of the hood 118 (FIG. 2) of the extractor 66 can reduce the losses.

In various examples, the sensor system 98 may additionally or alternatively include one or more harvester-performance sensors 102 configured to generate data indicative of a proportion of foliage to crop material (i.e., foliage ratio). In several cases, the data analysis module 276 may determine a cleaning performance indicator based at least in part on the data provided by the one or more harvester-performance sensors 102. As used herein, the cleaning performance indicator may be representative of one or more quantifiable measures of the fan assembly performance over time, such as debris 64 removably from the crop flow, which may be represented as a detected foliage ratio. In some examples, an increase in distance between the fan blades 128 and an upper portion 148 of the hood 118 can increase the ability to remove additional debris 64.

In various examples, the sensor system 98 may additionally or alternatively include one or more fan operation sensors 104 configured to generate data indicative of the operating conditions of the fan assembly 68 within the extractor 66 and/or one or more extractor airflow sensors 106 configured to generate data indicative of an airflow metric associated with the extractor 66. In some examples, the data analysis module 276 may determine a fan power efficiency performance indicator based at least in part on the data provided by the one or more fan operation sensors 104, the one or more extractor airflow sensors 106, and/or the cleaning performance indicator. As used herein, the fan power efficiency performance indicator may be representative of a power consumption per suction force generated (e.g., a vortex generated consuming energy without performing). In some cases, the distance between the fan blades 128 and an upper portion 148 of the hood 118 may be altered to change various conditions represented by the fan power efficiency performance indicator.

Based at least in part on the loss performance indicator, the cleaning performance indicator, and/or the fan power efficiency performance indicator, the data analysis module 276 can determine a defined position of a component of the fan assembly 68 (e.g., the one or more fan blades 128, the hub 126, etc.) relative to a hood 118 of the fan assembly 68 (and/or any other component of the harvester 10) based at least in part on the data from the sensor system 98 with a computing system 252. In turn, the control module 278 may alter a position of the fan blades 128 relative to the hood 118, the barrel 120, and/or any other component of the harvester 10 through the actuation of an actuator 164 within the adjustment assembly 162. Due to the activation of the actuator 164, changes with one or more other harvesting components 284, and/or changes within a harvesting environment, the harvesting conditions may be altered. The sensors may alter the harvesting conditions and provide data to the data analysis module 276 to generate one or more subsequent fan actuator 164 controls thereby allowing for closed-loop control of the adjustment assembly 162 during the use of the harvester 10.

Referring now to FIG. 17, a flow diagram of a method 300 for operating an agricultural harvester is illustrated in accordance with aspects of the present subject matter. In general, the method 300 will be described herein with reference to the agricultural harvester 10 and related components described with reference to FIGS. 1-14, and the various components of the system 250 described with reference to FIGS. 15 and 16. It will be appreciated, however, that the disclosed method 300 may be implemented with harvesters having any other suitable configurations and/or within systems having any other suitable system configuration. In addition, although FIG. 17 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 17, at (302), the method 300 may include operating a fan assembly to generate a suction force within an extractor. In some instances, the suction force draws debris away from a stream of billets expelled from a chopper assembly and into an airflow channel defined by an extractor housing for subsequent delivery to an extractor outlet. The cleaned billets may then fall onto an elevator assembly for transport to a suitable receiver.

At (304), the method 300 can include actuating an actuator operably coupled with a first arm of a support assembly to move a fan blade of the fan assembly from a first offset distance relative to an upper portion of the hood to a second offset distance relative to the upper portion of the hood. In some cases, actuating the actuator can further include providing a liquid from a reservoir to the actuator to alter the position of the first arm. Additionally or alternatively, actuating the actuator can further include providing electric power to the actuator to alter the position of the first arm.

At (306), the method 300 can include guiding a second arm of the support assembly along a guide at the fan assembly that is moved from the first offset distance relative to the upper portion of the hood to the second offset distance relative to the upper portion of the hood.

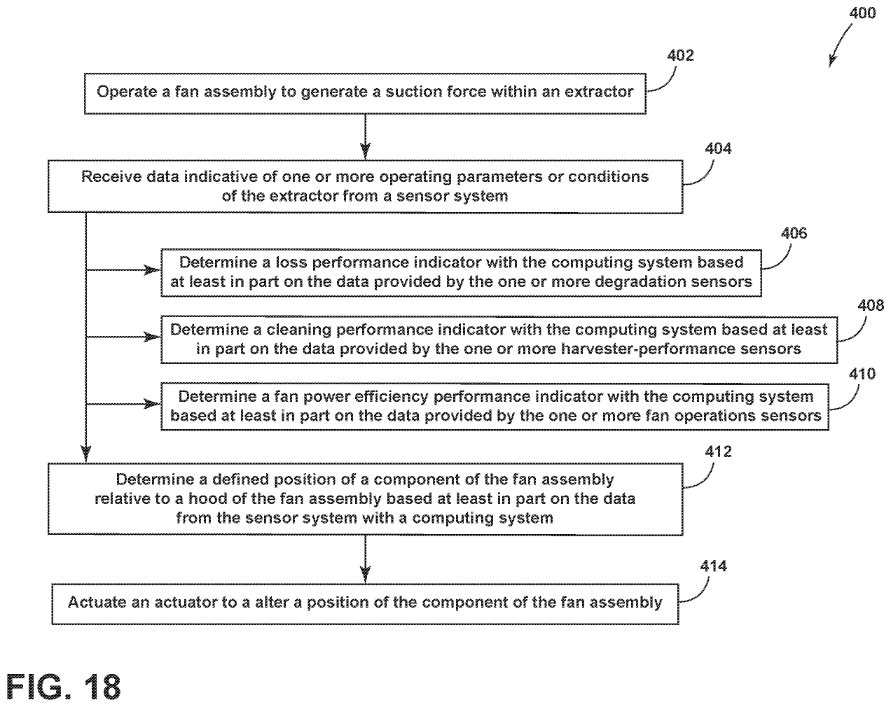

Referring now to FIG. 18, a flow diagram of a method 400 for operating an agricultural harvester is illustrated in accordance with aspects of the present subject matter. In general, the method 400 will be described herein with reference to the agricultural harvester 10 and related components described with reference to FIGS. 1-14, and the various components of the system 250 described with reference to FIGS. 15 and 16. It will be appreciated, however, that the disclosed method 400 may be implemented with harvesters having any other suitable configurations and/or within systems having any other suitable system configuration. In addition, although FIG. 18 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 18, at (402), the method 400 may include operating a fan assembly to generate a suction force within an extractor. In some instances, the suction force draws debris away from a stream of billets expelled from a chopper assembly and into an airflow channel defined by an extractor housing for subsequent delivery to an extractor outlet. The cleaned billets may then fall onto an elevator assembly for transport to a suitable receiver.

At (404), the method 400 can include receiving data indicative of one or more operating parameters or conditions of the extractor from a sensor system. As provided herein, the sensor system can include various onboard sensors for monitoring one or more operating parameters or conditions of the harvester. For instance, the sensor system may include one or more degradation sensors configured to generate data indicative of one or more conditions of the extractor during operation of the harvester (e.g., objects impacting the hood or other components of the extractor, an amount of fan vibration, various impact or operating sounds, visual changes to the extractor, etc.). Additionally or alternatively, the sensor system may include one or more harvester-performance sensors configured to generate data indicative of a proportion of foliage to crop material. Additionally or alternatively, the sensor system may include one or more fan operation sensors configured to generate data indicative of the operating conditions of the fan assembly within the extractor. Additionally or alternatively, the sensor system may include one or more extractor airflow sensors configured to generate data indicative of an airflow metric associated with the extractor.

In some cases, at (406), the method 400 can include determining a loss performance indicator with the computing system based at least in part on the data provided by the one or more degradation sensors. Additionally or alternatively, at (408), the method 400 can include determining a cleaning performance indicator with the computing system based at least in part on the data provided by the one or more harvester-performance sensors. Additionally or alternatively, at (410), the method 400 can include determining a fan power efficiency performance indicator with the computing system based at least in part on the data provided by the one or more fan operation sensors.

At (412), the method 400 can include determining a defined position of a component of the fan assembly relative to a hood of the fan assembly based at least in part on the data from the sensor system with a computing system. In various examples, the defined position may be based at least in part on a loss performance indicator, a cleaning performance indicator, and/or a fan power efficiency performance indicator.

At (414), the method 400 can include actuating an actuator to alter a position of the component of the fan assembly. In several examples, alters a position of a common unit operably coupled with the fan component relative to the hood. In some cases, actuating the actuator can further include providing a liquid from a reservoir to the actuator to alter the position of the common unit. Additionally or alternatively, actuating the actuator can further include providing electric power to the actuator to alter the position of the common unit.

In various examples, the methods 300, 400 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud. In some instances, the machine learning engine may allow for changes to the extractor to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An extractor configured to separate debris from a crop and expel the debris therefrom, the extractor comprising:
a hood;
a fan assembly positioned at least partially within the hood and configured to generate a suction force to force the debris through the extractor, the fan assembly including a fan blade;
an actuator configured to alter a position of the fan blade relative to an upper portion of the hood;
a sensor system configured to generate data indicative of one or more operating parameters or conditions of the extractor; and
a computing system communicatively coupled to the sensor system and the actuator, the computing system being configured to:
receive the data from the sensor system; and
determine a defined position of the fan blades relative to the hood based at least in part on the data from the sensor system.

2. The extractor of claim 1, wherein the computing system is further configured to activate the actuator to move the fan blade from a current position to the defined position.

3. The extractor of claim 1, wherein the sensor system includes one or more degradation sensors configured to generate data indicative of one or more conditions of the extractor.

4. The extractor of claim 3, wherein the computing system is further configured to determine a loss performance indicator based at least in part on the data provided by the one or more degradation sensors.

5. The extractor of claim 4, wherein the defined position is based at least in part on the loss performance indicator.

6. The extractor of claim 1, wherein the sensor system includes one or more harvester-performance sensors configured to generate data indicative of a proportion of foliage to crop material.

7. The extractor of claim 6, wherein the computing system is further configured to determine a cleaning performance indicator based at least in part on the data provided by the one or more harvester-performance sensors.

8. The extractor of claim 7, wherein the defined position is based at least in part on the cleaning performance indicator.

9. The extractor of claim 1, wherein the sensor system includes one or more fan operation sensors configured to generate data indicative of the operating conditions of the fan assembly within the extractor.

10. The extractor of claim 9, wherein the computing system is further configured to determine a fan power efficiency performance indicator based at least in part on the data provided by the one or more fan operation sensors.

11. The extractor of claim 1, wherein the sensor system includes one or more extractor airflow sensors configured to generate data indicative of an airflow metric associated with the extractor.

12. The extractor of claim 11, wherein the computing system is further configured to determine a fan power efficiency performance indicator based at least in part on the data provided by the one or more extractor airflow sensors.

13. A computer-implemented method for agricultural harvesting, the computer-implemented method comprising:
operating a fan assembly to generate a suction force within an extractor;
receiving, from a sensor system, data indicative of one or more operating parameters or conditions of the extractor; and
determining, with a computing system, a defined position of a component of the fan assembly relative to a hood of the fan assembly based at least in part on the data from the sensor system.

14. The computer-implemented method of claim 13, further comprising:
actuating an actuator to alter a position of the component of the fan assembly.

15. The computer-implement method of claim 14, wherein actuating the actuator alters a position of a common unit operably coupled with the fan component relative to the hood.

16. An extractor configured to separate debris from a crop and expel the debris therefrom, the extractor comprising:
a fan assembly positioned configured to generate a suction force to force the debris through the extractor, the fan assembly including a fan blade;
an actuator configured to alter a position of the fan blade within the extractor;
a sensor system configured to generate data indicative of one or more operating parameters or conditions of the extractor; and
a computing system communicatively coupled to the sensor system and the actuator, the computing system being configured to:
receive the data from the sensor system; and
activate the actuator to move the fan blade from a current position to a defined position based at least in part on the data from the sensor system.

17. The extractor of claim 16, wherein the computing system is further configured to determine a loss performance indicator, and wherein the defined position is based at least partially on the loss performance indicator.

18. The extractor of claim 16, wherein the computing system is further configured to determine a cleaning performance indicator, and wherein the defined position is based at least partially on the cleaning performance indicator.

19. The extractor of claim 18, wherein the computing system is further configured to determine a fan power efficiency performance indicator based at least in part on data provided by one or more fan operation sensors, one or more extractor airflow sensors, and the cleaning performance indicator, and wherein the defined position is based at least partially on the fan power efficiency performance indicator.

20. The extractor of claim 16, wherein the computing system is further configured to determine a fan power efficiency performance indicator, and wherein the defined position is based at least partially on the fan power efficiency performance indicator.
